(19) United States
(12) Patent Application Publication
(10) Pub. No.: US 2009/0272026 A1
(43) Pub. Date: Nov. 5, 2009

(54) BENDABLE ELECTRIC MOSQUITO SWATTER

(76) Inventor: Kuei-Tzu SU, Taichung Hsien (TW)

Correspondence Address: BROWDY AND NEIMARK, P.L.L.C.;624 NINTH STREET, NW, SUITE 300, WASHINGTON, DC, 20001-5303, US

(21) Appl. No.: 12/127,440

(22) Filed: May 27, 2008

(30) Foreign Application Priority Data
May 2, 2008 (TW) 097116230

(51) Int. Cl. A01M 3/02; A01M 1/22

(52) U.S. Cl. 43/137; 43/112

(57) ABSTRACT

A bendable electric mosquito swatter includes a handle having a battery therein and a switch, a swatter head having a wire net, and a flexible metal member connecting the handle and the swatter head and conducting the battery to the wire net. The present invention further includes a plurality of barrels fitted to the flexible metal member in a serial connection to form a shaft. Each of the barrels is provided with inclined faces on a front end and a rear end respective that forms an angle between the corresponding inclined faces of the neighboring barrels respectively. The barrels allows the shaft bending and limits the maximum bending angle by the corresponding inclined faces of the neighboring barrels touching each other.

### BACKGROUND OF THE INVENTION

1. Field of the Invention

The present invention relates generally to an electric mosquito swatter and, more particularly to a bendable electric mosquito swatter having a limited bending angle.

2. Description of the Related Art

Typically, conventional electric mosquito swatters have a rigid shaft, which connecting a handle and a swatter head that is inconvenient for user to kill a mosquito on the wall or on the roof. User has to turn the swatter head parallel to the wall that may have chance the kill the mosquito. An improved electric mosquito swatter having a bendable shaft had been brought to the market in recent time. Such bendable electric mosquito swatter has several drawbacks because of the bendable material. For example, some bendable electric mosquito swatters make the shaft by rubber. A soft rubber may not return the shaft to a straight condition, and the hard rubber will make the shaft been broken easily. Another bendable electric mosquito swatter has the shaft made of carbon fiber or glass fiber. Such electric mosquito swatter only provides a very small bending angle and is easy to be broken when the shaft is over bent. There are bendable electric mosquito swatters made of flexible metal, which provides a greater bending angle and has less chance to be broken, but the shaft will not return to the straight condition when it is over bent.

### SUMMARY OF THE INVENTION

The primary objective of the present invention is to provide a bendable electric mosquito swatter, which always may return to the straight condition.

To achieve the objective of the present invention, a bendable electric mosquito swatter includes a handle, a swatter head having a wire net, and a flexible metal member connecting the handle and the swatter head and conducting a battery in the handle to the wire net. The present invention further includes a plurality of barrels fitted to the flexible metal member to form a shaft. Between the neighboring barrels is an angle respectively that allows the shaft bending and limits the maximum bending angle by the neighboring barrels touching each other.

### BRIEF DESCRIPTION OF THE DRAWINGS

FIG. 1 is a perspective view of a first preferred embodiment of the present invention;

FIG. 2 is a lateral view of the first preferred embodiment of the present invention;

FIG. 3 is an enlarged view of a part of the shaft of FIG. 2;

FIG. 4 is a sectional view along the 4-4 line of FIG. 2;

FIG. 5 is an enlarged view of a part of the shaft of FIG. 4;

FIG. 6 is a lateral view of the preferred embodiment of the present invention, showing the shaft been bent:

FIG. 7 is an enlarged view of a part of the shaft of FIG. 6;

FIG. 8 is a sectional view of a part of the shaft of FIG. 6;

FIG. 9 is an enlarged view of a part of the shaft of a second preferred embodiment of the present invention; and

FIG. 10 is a sectional view of a part of the shaft of the second preferred embodiment of the present invention.

### DETAILED DESCRIPTION OF THE INVENTION

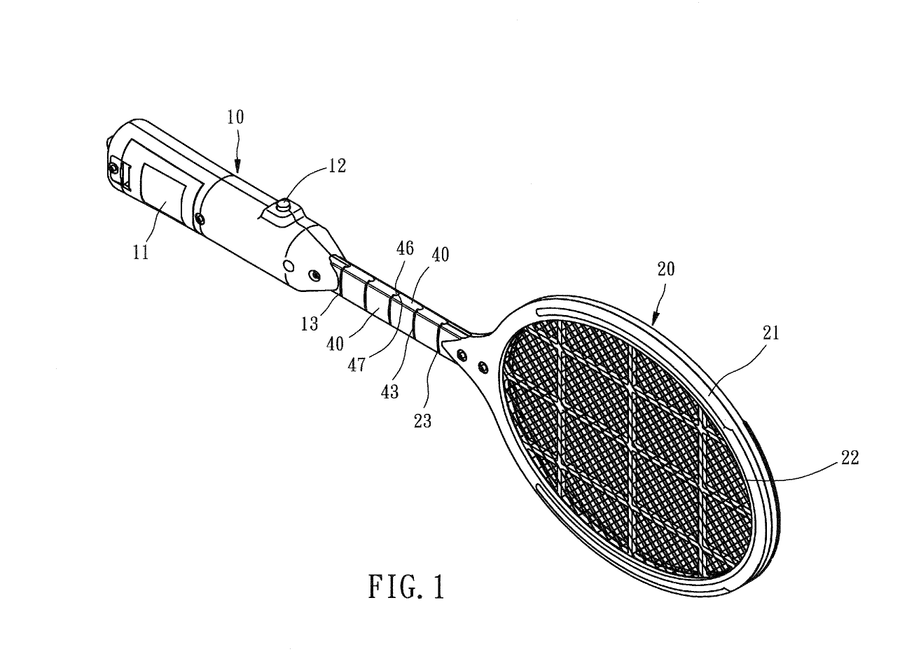

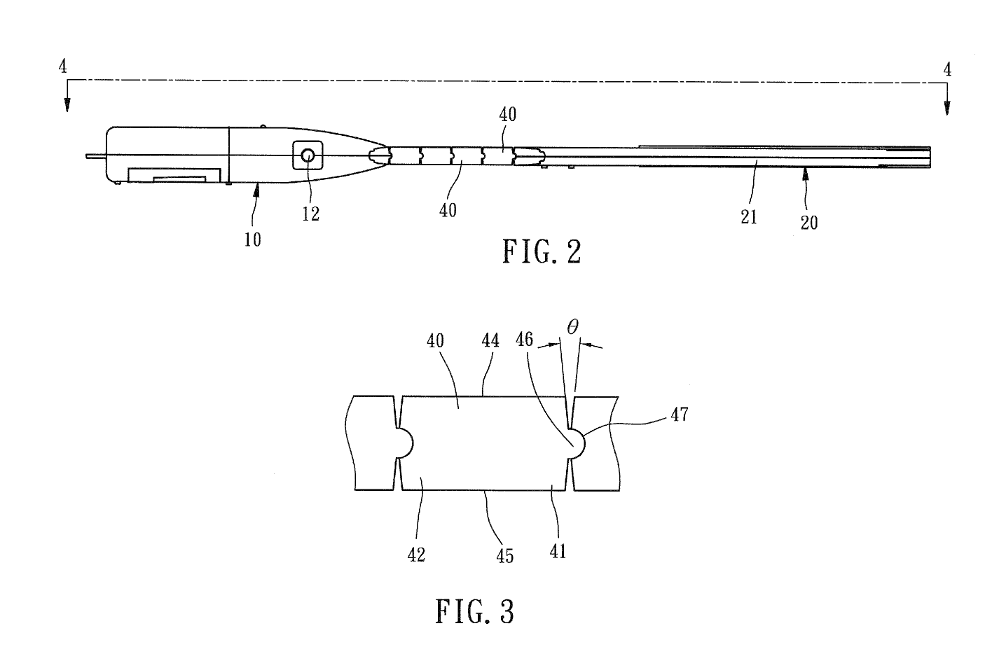

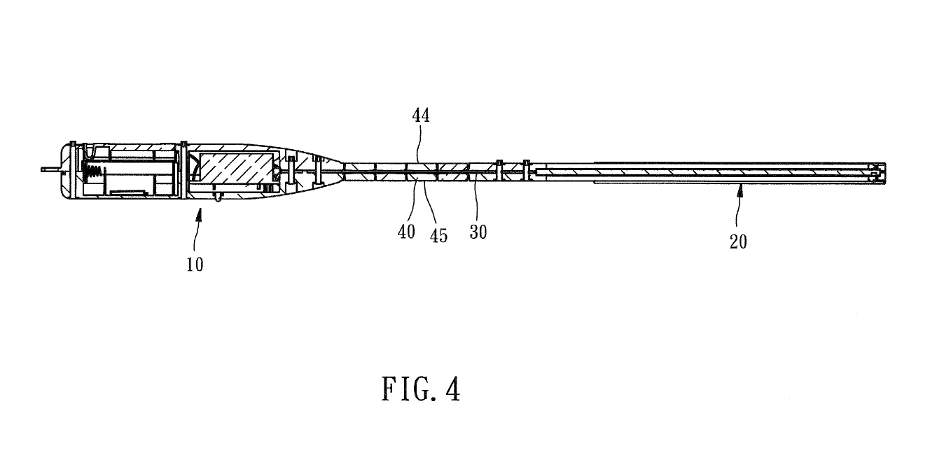

As shown in FIGS. 1 to 5, a bendable electric mosquito swatter of the first preferred embodiment of the present invention includes:

A handle 10, to be held by user, receives batteries 11 therein and has a switch 12 thereon.

A swatter head 20 has a frame 21 and a wire net 22.

A flexible metal member 30 connects the handle 10 and the swatter head 20 and conducts the batteries 11 to wires of the wire net 22.

The character of the present invention includes:

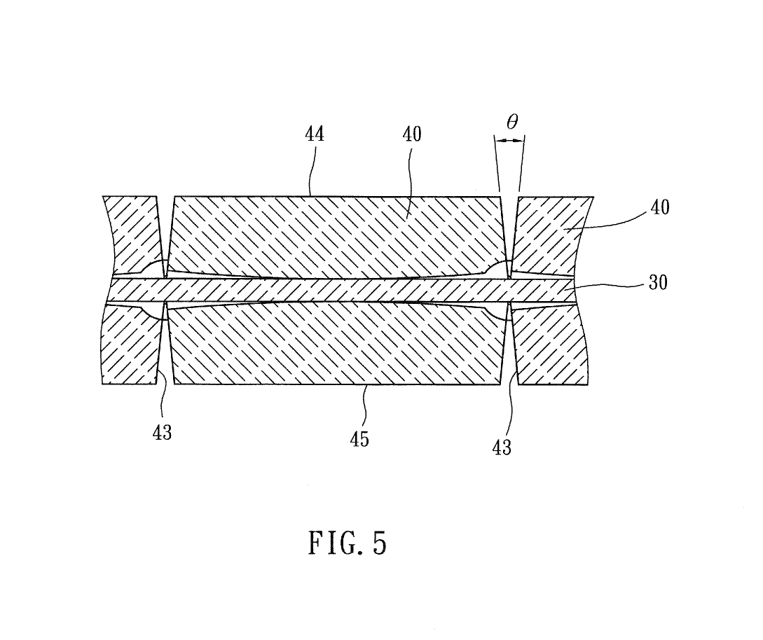

The flexible metal member 30 is fitted with a plurality of barrels 40. The barrels 40 are in series connection to form a shaft of the swatter with the flexible metal member 30. Each of the barrels 40 has a front end 41, a rear end 42, a top side 44 and a bottom side 45. On the front end 41 and the rear end 42 have two inclined faces 43 respectively. The inclined faces 43 on the front end 41 are sloped from the top side 44 or the bottom side 45 towards the front end 41, and the inclined faces 43 on the rear end 42 are sloped from the top side 44 or the bottom side 45 towards the rear end 42. The corresponding inclined faces 43 of the neighboring barrels 40 form an angle θ. The angle may be in a range between 5 degrees and 17 degrees, more preferred is between 8 degrees and 14 degrees, as shown in FIG. 3 and FIG. 5. The range of the angle θ is associated with the flexible metal member 30, and both of them determine the maximum bending angle of the swatter.

Each of the barrels 40 has two protrusions 46 on opposite lateral sides of the front end 41 and two slots 47 on opposite lateral sides of the rear ends 42. The protrusions 46 are engaged with the slots 47 of the neighboring barrel 40 to serially and pivotally connect the barrels 40.

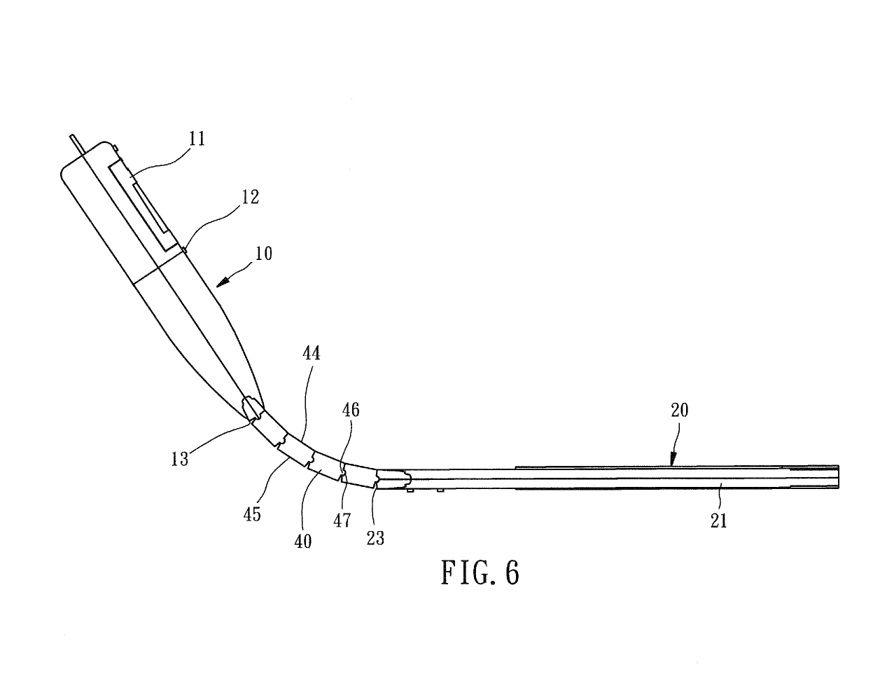

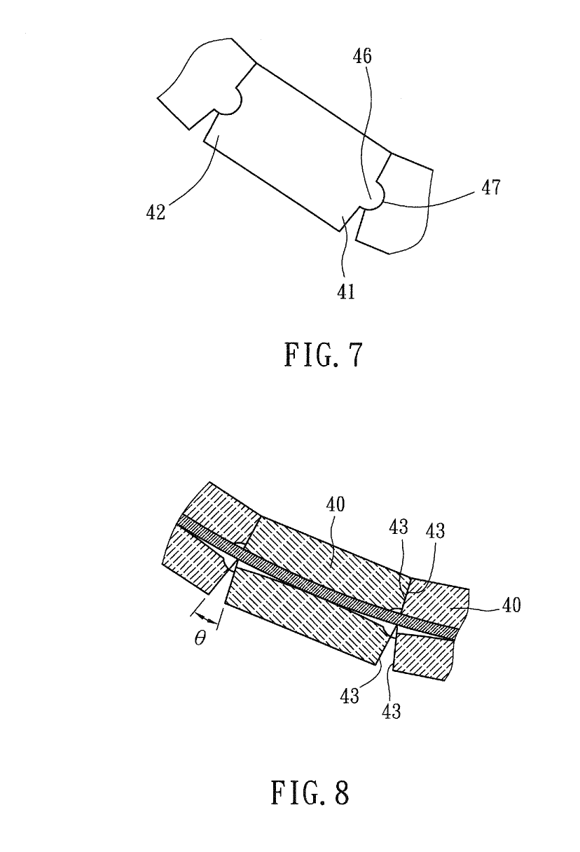

The way of operate the bendable electric mosquito swatter of the present invention is as same as the conventional device. User may hold the handle 10 and press the switch 12 to charge the wire net 22 to kill mosquitoes. The different part is the bending angle of the present invention is limited by the inclined faces 43 of the barrels 40. As shown in FIG. 6 to FIG. 8, when the electric mosquito swatter of the present invention is bent, the flexible metal member 30 is bent and the barrels 40 are sloped respectively. The angles θ on an inner side decrease, and the angles θ on an outer side increase. When the inclined faces 43 on the inner sides touch each other, the bendable electric mosquito swatter of the present invention can not be bent anymore that may prevent the flexible metal member 30 from over bend.

On the handle 10 and the swatter head 20 are provided with two inclined faces 13, 23 respectively for the inclined faces 43 on the rear end 42 of the last barrel 40 and the inclined faces 43 on the front end 41 of the first barrel 40. This may provides a firm support.

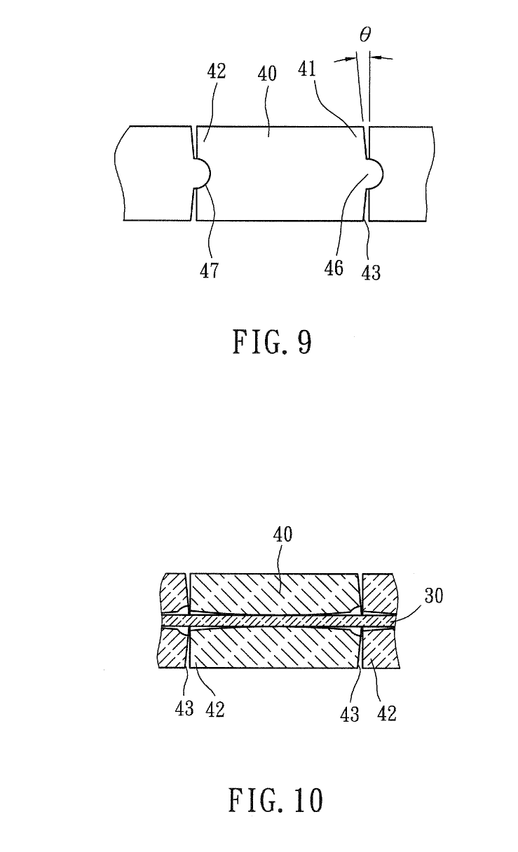

As shown in FIG. 9 and FIG. 10, a bendable electric mosquito swatter of the second preferred embodiment of the present invention, same as the first preferred embodiment, has a handle 10, a swatter head 20, a flexible metal member 30, and a plurality of barrels 40 having protrusions 46 and slots 47. The different part of the second preferred embodiment is that the barrels 40 have inclined faces 43 on front ends 41 only. Although no inclined face on the rear ends of the barrels 40, there still are angles θ between the neighboring front ends 41 and the rear ends of the neighboring barrels 40. A range of the angle θ is in a range between 5 degrees and 17 degrees, more preferred is between 8 degrees and 14 degrees. The function of the second preferred embodiment is as same as the first preferred embodiment that the barrels 40 will limit the flexible metal member 30 only bending in a predetermined range to prevent the flexible metal member 30 from over bend.

Although the particular embodiments of the invention has been described in detail for purposes of illustration, various modifications and enhancements may be made without departing from the spirit and scope of the invention. Accordingly, the invention is not to be limited except as by the appended claims.

What is claimed is:

1. A bendable electric mosquito swatter, comprising:
a handle, which is held by an user, having a battery therein and a switch thereon;
a swatter head having a frame and a wire net on said frame;
a flexible metal member connecting said handle and said swatter head and conducting said battery to said wire net; and
a plurality of barrels fitted to said flexible metal member to form a shaft, wherein each of said barrels has a front end and a rear end, and on each of said front ends and said rear ends is provided with two inclined faces to form an angle between said neighboring inclined faces on said neighboring barrels respectively.

2. The bendable electric mosquito swatter as claimed in claim 1, wherein each of said barrels has a top side and a bottom side, and each of said inclined faces on said front sides is sloped from said top side or said bottom side towards said front side, each of said inclined faces on said rear sides is sloped from said top side or said bottom side towards said rear side.

3. The bendable electric mosquito swatter as claimed in claim 1, wherein a maximum value of said angle is in a range between 5 degrees and 17 degrees.

4. The bendable electric mosquito swatter as claimed in claim 1, wherein each of said barrels has two protrusions on opposite sides of said front end and two slots on opposite sides of said rear end to be engaged with said protrusions on said neighboring barrel.

5. The bendable electric mosquito swatter as claimed in claim 1, wherein said handle is provided with two inclined faces corresponding to said inclined faces on said rear end of said last barrel.

6. The bendable electric mosquito swatter as claimed in claim 1, wherein said swatter head are provided with two inclined faces corresponding to said inclined faces on said front end of said first barrel.

7. A bendable electric mosquito swatter, comprising:
a handle, which is held by an user, having a battery therein and a switch thereon;
a swatter head having a frame and a wire net on said frame;
a flexible metal member connecting said handle and said swatter head and conducting said battery to said wire net; and
a plurality of barrels fitted to said flexible metal member to form a shaft,
wherein each of said barrels has a front end and a rear end, and on each of barrels is provided with two inclined faces to form an angle between said inclined face and said rear end on said neighboring barrels respectively.

8. The bendable electric mosquito swatter as claimed in claim 7, wherein each of said barrels has a top side and a bottom side, and each of said inclined faces on said front sides is sloped from said top side or said bottom side towards said front side.

9. The bendable electric mosquito swatter as claimed in claim 7, wherein a maximum value of said angle is in a range between 5 degrees and 17 degrees.

10. The bendable electric mosquito swatter as claimed in claim 7, wherein each of said barrels has two protrusions on opposite sides of said front end and two slots on opposite sides of said rear end to be engaged with said protrusions on said neighboring barrel.
